(19) United States
(12) Patent Application Publication
(10) Pub. No.: US 2023/0360037 A1
(43) Pub. Date: Nov. 9, 2023

(54) CONTROL SYSTEM, STORAGE MEDIUM, AND CONTROL METHOD

(71) Applicant: FUJITSU LIMITED, Kawasaki-shi (JP)

(72) Inventor: Shingo FUJIMOTO, Yokohama (JP)

(73) Assignee: FUJITSU LIMITED, Kawasaki-shi (JP)

(21) Appl. No.: 18/355,797

(22) Filed: Jul. 20, 2023

Related U.S. Application Data
(63) Continuation of application No. PCT/JP2021/007214, filed on Feb. 25, 2021.

(51) Int. Cl. G06Q 20/38; G06Q 20/40; H04L 9/32

(52) U.S. Cl. CPC G06Q 20/382; G06Q 20/407; H04L 9/3297

(57) ABSTRACT

A control system includes a plurality of nodes configured to: manage a first blockchain that records a scheduled time point at which transaction information is enabled, specify the transaction information for which the scheduled time point has elapsed based on contents of the first blockchain, and record the specified transaction information in the first blockchain; one or more nodes; an information processing device configured to transmit the transaction information specified by a node of the plurality of nodes that satisfies a certain condition among the plurality of nodes to each node of the one or more nodes based on the recorded of the first blockchain, wherein each node of the one or more nodes is configured to: manage a second blockchain that records enabled transaction information, generate a block that includes the transaction information, and add the block to the second blockchain.

### CROSS-REFERENCE TO RELATED APPLICATION

This application is a continuation application of International Application PCT/JP2021/007214 filed on Feb. 25, 2021 and designated the U.S., the entire contents of which are incorporated herein by reference.

### FIELD

The present invention relates to a control system, a storage medium, and a control method.

### BACKGROUND

Conventionally, there is a list called a blockchain that implements a distributed ledger for managing transaction information by linking blocks in which the transaction information is recorded. For example, the blockchain is used in a decentralized financial system. At this time, it may be desirable to schedule an operation of recording transaction information in the blockchain so that the transaction information indicating transaction content such as transfer of money, transfer of rights, or the like is recorded in the blockchain after a designated time point elapses.

There is an example of prior art in which at least a predetermined node of a plurality of nodes forming a distributed ledger system executes an operation smart contract for operation management based on whether or not a type of a received transaction is the operation smart contract.

Patent Document 1: Japanese Laid-open Patent Publication No. 2019-028525

### SUMMARY

According to an aspect of the embodiments, a control system includes a plurality of nodes that forms a first blockchain network, each node of the plurality of nodes is configured to: manage a first blockchain that records a scheduled time point at which transaction information is enabled, specify the transaction information for which the scheduled time point has elapsed based on recorded contents of the first blockchain, and record the specified transaction information in the first blockchain; one or more nodes that form a second blockchain network; an information processing device configured to transmit the transaction information specified by a node of the plurality of nodes that satisfies a certain condition among the plurality of nodes to each node of the one or more nodes based on the recorded contents of the first blockchain, wherein each node of the one or more nodes is configured to: manage a second blockchain that records enabled transaction information, generate a block that includes the transaction information transmitted by the information processing device, and add the block to the second blockchain.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a control method according to an embodiment;

FIG. 2 is an explanatory diagram illustrating an example of a control system 110;

FIG. 3 is a block diagram illustrating an exemplary hardware configuration of an information processing device 100;

FIG. 4 is a block diagram illustrating an exemplary hardware configuration of a first node 101;

FIG. 5 is an explanatory diagram illustrating an example of storage contents of scheduled transaction management information 500;

FIG. 6 is a block diagram illustrating an exemplary hardware configuration of a second node 102;

FIG. 7 is a block diagram illustrating an exemplary functional configuration of the control system 110;

FIG. 8 is an explanatory diagram (part 1) illustrating exemplary operation of the control system 110;

FIG. 9 is an explanatory diagram (part 2) illustrating exemplary operation of the control system 110;

FIG. 10 is an explanatory diagram (part 3) illustrating exemplary operation of the control system 110;

FIG. 11 is an explanatory diagram (part 4) illustrating exemplary operation of the control system 110;

FIG. 12 is an explanatory diagram (part 1) illustrating a specific example of operation of the control system 110;

FIG. 13 is an explanatory diagram (part 2) illustrating a specific example of the operation of the control system 110;

FIG. 14 is an explanatory diagram (part 3) illustrating a specific example of the operation of the control system 110;

FIG. 15 is an explanatory diagram (part 4) illustrating a specific example of the operation of the control system 110; and

FIG. 16 is a flowchart illustrating an example of an overall processing procedure.

### DESCRIPTION OF EMBODIMENTS

According to the related art, it is difficult to schedule an operation of recording transaction information in the blockchain. For example, it is difficult to synchronize time in individual nodes of the plurality of nodes that manage the blockchain, and it is difficult to schedule the operation of recording transaction information in the blockchain unless an external device that performs timer processing is introduced.

In one aspect, an object of the present invention is to enable scheduling of an operation of recording transaction information in a blockchain.

According to an aspect, it becomes possible to schedule an operation of recording transaction information in a blockchain.

Hereinafter, an embodiment of a control system, a control program, a control method, and a control device according to the present invention will be described in detail with reference to the drawings.

### Example of Control Method According to Embodiment

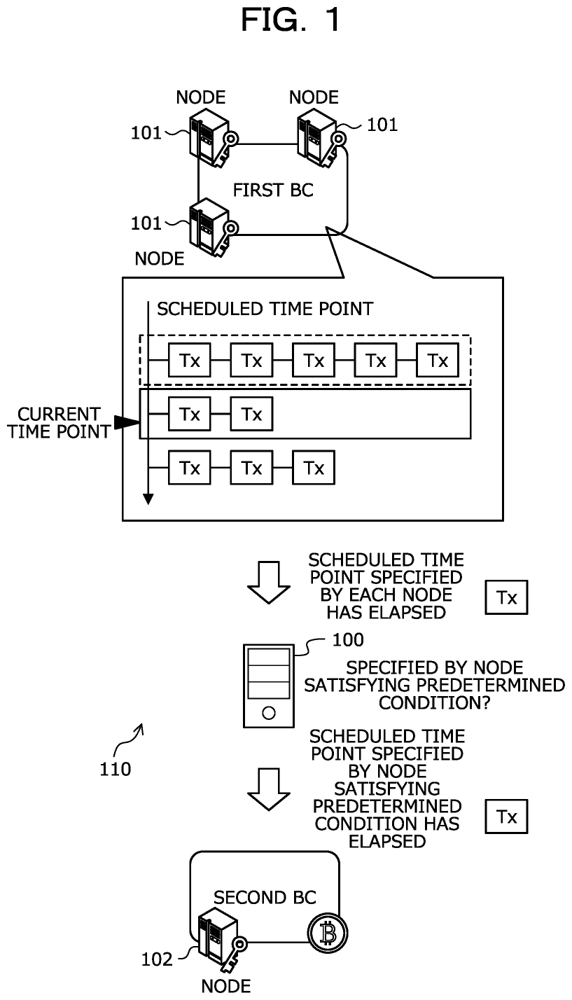

FIG. 1 is an explanatory diagram illustrating an example of a control method according to an embodiment. An information processing device 100 is a computer that may cooperate with a blockchain network and enables scheduling of an operation of recording transaction information in a blockchain. In the following descriptions, a blockchain may be referred to as a “BC”.

The BC network manages the BC. The BC network is formed by one or more nodes. For example, the BC is managed by each node included in the BC network storing and monitoring the same BC. The BC is a list that implements a distributed ledger for managing transaction information by linking blocks in which the transaction information is registered. As an example of the BC network, there is a public type, consortium type, or private type BC network.

The transaction information is called, for example, a transaction (Tx) information. In the following descriptions, the transaction may be referred to as a “Tx”. The BC implements, for example, distributed ledger technology in which it is difficult to falsify transaction information registered in a block.

Here, it is conceivable that the BC is used in a decentralized financial system to be utilized for credit management, for example. In the credit management, it is desirable to determine a transaction schedule such that a transaction such as transfer of money, transfer of rights, or the like is carried out at a predetermined time point. The transfer of rights indicates, for example, redemption of investments, a dividend payment, or the like. Thus, it is desirable to enable scheduling of the operation of recording transaction information in the BC such that the transaction information indicating transaction content is recorded in the BC after the designated time point elapses.

However, according to the related art, it is difficult to schedule the operation of recording transaction information in the BC. For example, it is difficult to synchronize time in individual nodes that manage the BC and form the BC network. Thus, it is difficult to schedule the operation of recording transaction information in the BC unless an external device that performs timer processing is combined with the BC network.

For example, a method called Ethereum Alarm Clock is conceivable. For this method, for example, the following Reference Document 1 and the like may be referred to. According to this method, an external device that performs timer processing holds a timer, which causes a problem that a processing load increases.

Reference Document 1: “ETHEREUM ALARM CLOCK”, [online], [searched on Feb. 16, 2021], Internet <URL: https://www.ethereum-alarm-clock.com/>

In view of the above, in the present embodiment, a control method that enables scheduling of the operation of recording transaction information in the BC will be described.

In FIG. 1, there is a control system 110 including a plurality of first nodes 101 that forms a first BC network, one or more second nodes 102 that form a second BC network, and the information processing device 100. The information processing device 100 may cooperate with the first BC network and the second BC network.

(1-1) Each of the first nodes 101 manages a first BC that records a scheduled time point at which transaction information is enabled. The scheduled time point indicates a scheduled time point at which transaction information regarding a certain transaction is enabled in response to execution of the transaction. Each of the first nodes 101 specifies the transaction information for which the scheduled time point has elapsed based on recorded contents of the first BC managed by the node itself.

Each of the first nodes 101 records information indicating the specified transaction information for which the scheduled time point has elapsed in the first BC managed by the node itself. The information indicating the transaction information is, for example, the transaction information itself. Each of the first nodes 101 distributes the recorded contents of the first BC managed by the node itself to the information processing device 100. Processing of each of the first nodes 101 is implemented by, for example, a smart contract. In the following description, the smart contract may be referred to as an “SC”.

(1-2) The information processing device 100 obtains the recorded contents of the first BC. The information processing device 100 carries out consensus building based on the recorded contents of the first BC, and selects the transaction information specified by the first node 101 that satisfies a predetermined condition. The predetermined condition is, for example, the number of the first nodes 101. The predetermined condition may be, for example, a condition related to an attribute of the first node 101. For example, the information processing device 100 carries out the consensus building based on the recorded contents of the first BC, and selects the transaction information specified by equal to or more than a predetermined number of the first nodes 101 in common. The information processing device 100 transmits the information indicating the selected transaction information to each of the second nodes 102.

(1-3) Each of the second nodes 102 manages a second BC that records enabled transaction information. Each of the second nodes 102 receives information indicating transaction information from the information processing device 100. Each of the second nodes 102 generates a block including the received information indicating transaction information, and adds it to the second BC managed by the node itself.

As a result, the control system 110 is enabled to schedule an operation of recording transaction information in the second BC. For example, the information processing device 100 is interposed between the first BC network and the second BC network, and is capable of controlling the timing at which the information indicating transaction information is recorded in the second BC based on the scheduled time point recorded in the first BC. Thus, the information processing device 100 is enabled to schedule the operation of recording transaction information in the second BC in cooperation with the first BC network.

Furthermore, the information processing device 100 may select the transaction information specified by the first node 101 that satisfies a predetermined condition, and may set the transaction information as a target to be recorded in the second BC. For example, the information processing device 100 may select the transaction information specified by equal to or more than a predetermined number of the first nodes 101, and may set the transaction information as a target to be recorded in the second BC. Thus, the information processing device 100 is enabled to avoid a situation where the transaction information erroneously specified by any of the first nodes 101 is set as a target to be recorded in the second BC, which may improve security.

Although the case where the information indicating transaction information is the transaction information itself has been described here, it is not limited to this. For example, the information indicating transaction information may be identification information for identifying the transaction information. For example, the information indicating transaction information may be a feature value obtained from the transaction information. Specifically, the information indicating transaction information may be a hash value obtained from the transaction information.

(Exemplary Control System 110)

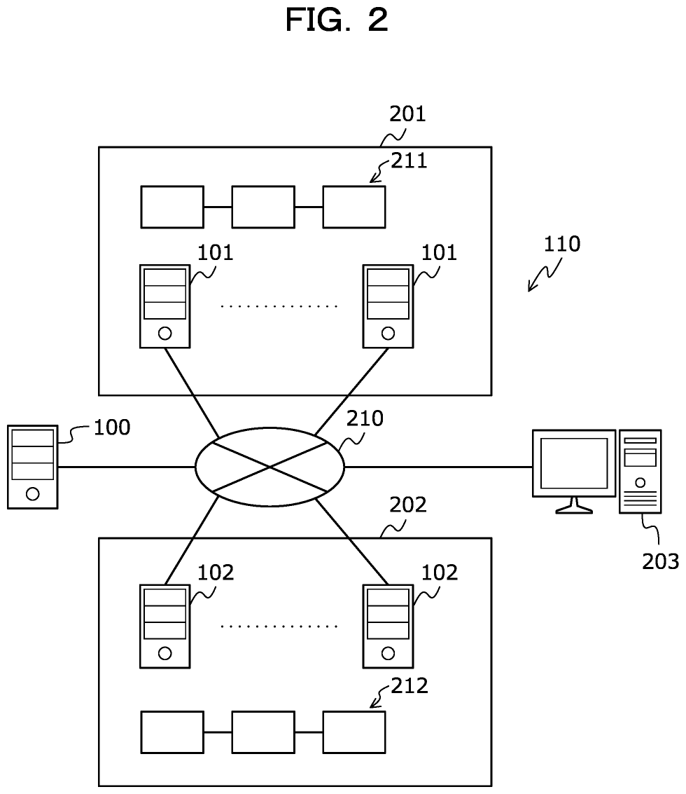

Next, an example of the control system 110 to which the information processing device 100 illustrated in FIG. 1, a first BC network 201, and a second BC network 202 are applied will be described with reference to FIG. 2.

FIG. 2 is an explanatory diagram illustrating an example of the control system 110. In FIG. 2, the control system 110 includes the information processing device 100, the first BC network 201, the second BC network 202, and a client device 203. The first BC network 201 is formed by a plurality of first nodes 101. The second BC network 202 is formed by one or more second nodes 102.

In the control system 110, the information processing device 100 and the first BC network 201 are coupled via a wired or wireless network 210. For example, the network 210 is a local area network (LAN), a wide area network (WAN), the Internet, or the like. Furthermore, in the control system 110, the information processing device 100 and the second BC network 202 are coupled via the network 210. Furthermore, in the control system 110, the first BC network 201 and the client device 203 are coupled via the network 210.

The information processing device 100 is a computer that may cooperate with the first BC network 201 and the second BC network 202. The information processing device 100 obtains recorded contents of a first BC 211 that records a scheduled time point at which transaction information is enabled. The scheduled time point indicates a scheduled time point at which transaction information regarding a certain transaction is enabled in response to execution of the transaction. The information processing device 100 carries out consensus building based on the recorded contents of the first BC 211, and selects the transaction information specified by the first node 101 that satisfies a predetermined condition. The information processing device 100 transmits the information indicating the selected transaction information to each of the second nodes 102. The information processing device 100 is, for example, a server, a personal computer (PC), or the like.

The first node 101 is a computer that manages the first BC 211. The first node 101 receives, from the client device 203, information indicating transaction information and a scheduled time point at which the transaction information is enabled, and records them in the first BC 211. The information indicating the transaction information is, for example, the transaction information itself. The first node 101 specifies the transaction information for which the scheduled time point has elapsed based on the recorded contents of the first BC 211 managed by the node itself. The first node 101 records information indicating the specified transaction information for which the scheduled time point has elapsed in the first BC 211. Processing of the first node 101 is implemented by, for example, a smart contract. The first node 101 is, for example, a server, a PC, or the like.

The second node 102 is a computer that manages the second BC 212 that records enabled transaction information. The second node 102 receives information indicating transaction information from the information processing device 100. The second node 102 records the received information indicating transaction information in the second BC 212 managed by the node itself. The second node 102 generates, for example, a block including the received information indicating transaction information, and adds it to the second BC 212 managed by the node itself. Processing of the second node 102 is implemented by, for example, a smart contract. The second node 102 is, for example, a server, a PC, or the like.

The client device 203 is a computer to be used by an executor of a certain transaction. The client device 203 transmits, to the individual first nodes 101, information indicating transaction information regarding the certain transaction and a scheduled time point at which the transaction information is enabled based on an operation input of the executor. The client device 203 is, for example, a PC, a tablet terminal, a smartphone, a wearable terminal, or the like. The control system 110 is applied to, for example, a decentralized financial system. The information processing device 100 may be any of the first nodes 101.

(Exemplary Hardware Configuration of Information Processing Device 100)

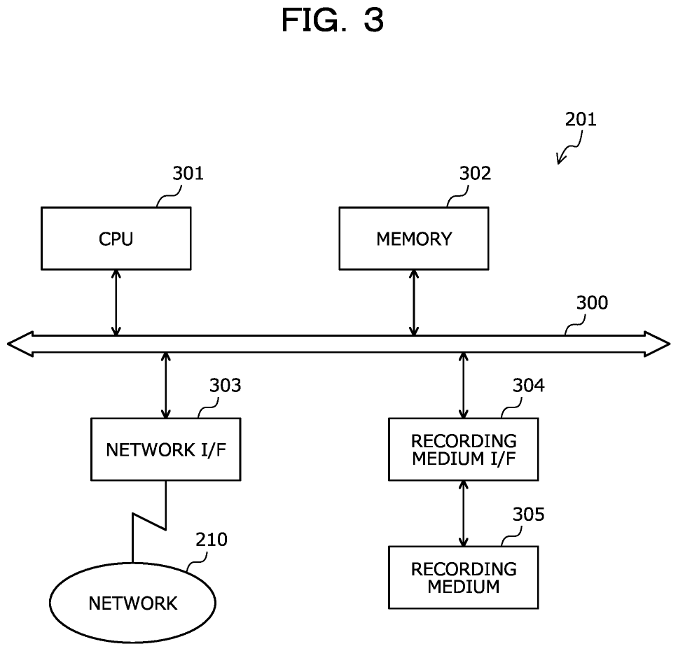

Next, an exemplary hardware configuration of the information processing device 100 will be described with reference to FIG. 3.

FIG. 3 is a block diagram illustrating an exemplary hardware configuration of the information processing device 100. In FIG. 3, the information processing device 100 includes a central processing unit (CPU) 301, a memory 302, a network interface (I/F) 303, a recording medium I/F 304, and a recording medium 305. Furthermore, the individual components are coupled to each other by a bus 300.

Here, the CPU 301 takes overall control of the information processing device 100. The memory 302 includes, for example, a read only memory (ROM), a random access memory (RAM), a flash ROM, and the like. Specifically, the flash ROM or the ROM stores various programs, and the RAM is used as a work area for the CPU 301, for example. The programs stored in the memory 302 are loaded into the CPU 301 to cause the CPU 301 to execute coded processing.

The network I/F 303 is coupled to the network 210 through a communication line, and is coupled to another computer via the network 210. Then, the network I/F 303 takes control of an interface between the network 210 and the inside, and controls input/output of data to/from the another computer. The network I/F 303 is, for example, a modem, a LAN adapter, or the like.

The recording medium I/F 304 controls read/write of data from/to the recording medium 305 under the control of the CPU 301. The recording medium I/F 304 is, for example, a disk drive, a solid state drive (SSD), a universal serial bus (USB) port, or the like. The recording medium 305 is a nonvolatile memory that stores data written under the control of the recording medium I/F 304. The recording medium 305 is, for example, a disk, a semiconductor memory, a USB memory, or the like. The recording medium 305 may be attachable to and detachable from the information processing device 100.

For example, the information processing device 100 may include, in addition to the components described above, a keyboard, a mouse, a display, a printer, a scanner, a microphone, a speaker, and the like. Furthermore, the information processing device 100 may include a plurality of the recording medium I/Fs 304 and the recording media 305. Furthermore, the information processing device 100 may not include the recording medium I/F 304 or the recording medium 305.

(Exemplary Hardware Configuration of First Node 101)

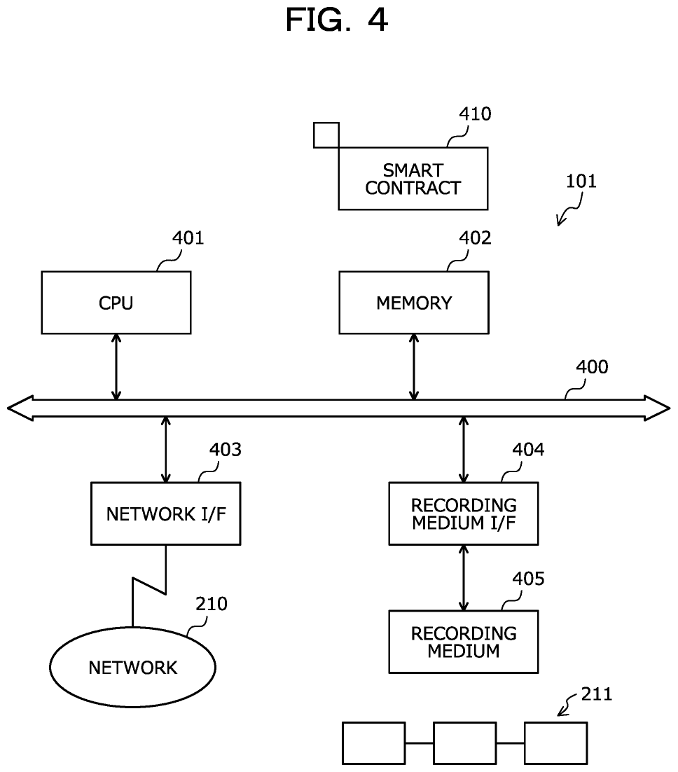

Next, an exemplary hardware configuration of the first node 101 will be described with reference to FIG. 4.

FIG. 4 is a block diagram illustrating an exemplary hardware configuration of the first node 101. In FIG. 4, the first node 101 includes a CPU 401, a memory 402, a network I/F 403, a recording medium I/F 404, and a recording medium 405. Furthermore, the individual components are coupled to each other by a bus 400.

Here, the CPU 401 takes overall control of the first node 101. The memory 402 includes, for example, a ROM, a RAM, a flash ROM, and the like. Specifically, the flash ROM or the ROM stores various programs, and the RAM is used as a work area for the CPU 401, for example. The programs stored in the memory 402 are loaded into the CPU 401 to cause the CPU 401 to execute coded processing.

Specifically, the memory 402 stores a smart contract 410. The smart contract 410 manages the first BC 211 that records a scheduled time point at which transaction information is enabled. The smart contract 410 receives, from the client device 203, information indicating transaction information and a scheduled time point at which the transaction information is enabled, and records them in the first BC 211. The smart contract 410 specifies the transaction information for which the scheduled time point has elapsed based on the recorded contents of the first BC 211 managed by the node itself, and records a result of the specification in the first BC 211.

The network I/F 403 is coupled to the network 210 through a communication line, and is coupled to another computer via the network 210. Then, the network I/F 403 takes control of an interface between the network 210 and the inside, and controls input/output of data to/from the another computer. The network I/F 403 is, for example, a modem, a LAN adapter, or the like.

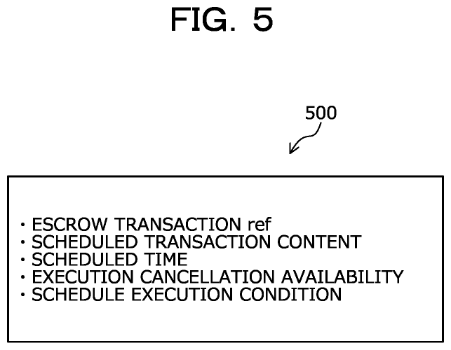

The recording medium I/F 404 controls read/write of data from/to the recording medium 405 under the control of the CPU 401. The recording medium I/F 404 is, for example, a disk drive, an SSD, a USB port, or the like. The recording medium 405 is a nonvolatile memory that stores data written under the control of the recording medium I/F 404. The recording medium 405 stores, for example, the first BC 211. The first BC 211 stores, for example, scheduled transaction management information 500 to be described later with reference to FIG. 5. The recording medium 405 is, for example, a disk, a semiconductor memory, a USB memory, or the like. The recording medium 405 may be attachable to and detachable from the first node 101.

For example, the first node 101 may include, in addition to the components described above, a keyboard, a mouse, a display, a printer, a scanner, a microphone, a speaker, and the like. Furthermore, the first node 101 may include a plurality of the recording medium I/Fs 404 and the recording media 405. Furthermore, the first node 101 may not include the recording medium I/F 404 or the recording medium 405.

(Storage Contents of Scheduled Transaction Management Information 500)

Next, an example of storage contents of the scheduled transaction management information 500 will be described with reference to FIG. 5. The scheduled transaction management information 500 is implemented by, for example, a storage area such as the memory 402 or the recording medium 405 of the information processing device 100 illustrated in FIG. 4.

FIG. 5 is an explanatory diagram illustrating an example of the storage contents of the scheduled transaction management information 500. As illustrated in FIG. 5, the scheduled transaction management information 500 includes fields of an escrow transaction ref, scheduled transaction contents, scheduled time, execution cancellation availability, and a schedule execution condition. The scheduled transaction indicates a transaction for which execution is scheduled.

In the field of the escrow transaction ref, identification information for identifying the escrow transaction to be referred to in the scheduled transaction is set. The escrow transaction is, for example, a transaction for depositing money to be handled by the scheduled transaction in a third party in advance. In the field of the scheduled transaction contents, contents of the above scheduled transaction to be executed with reference to contents of the above escrow transaction is set. The scheduled transaction contents indicate, for example, contents of a transaction of transmitting money, and specifically indicate a remittance amount, a destination to which the remittance amount of money is transmitted, and the like.

In the field of the scheduled time, scheduled time at which the above scheduled transaction is executed is set. In the field of the execution cancellation availability, information indicating whether or not execution of the above scheduled transaction may be canceled is set. In the field of the schedule execution condition, a condition for executing the above scheduled transaction is set. The above condition is, for example, that equal to or more than a predetermined number of the first nodes 101 determine that the above scheduled time has elapsed. The above condition may be different for each scheduled transaction.

(Exemplary Hardware Configuration of Second Node 102)

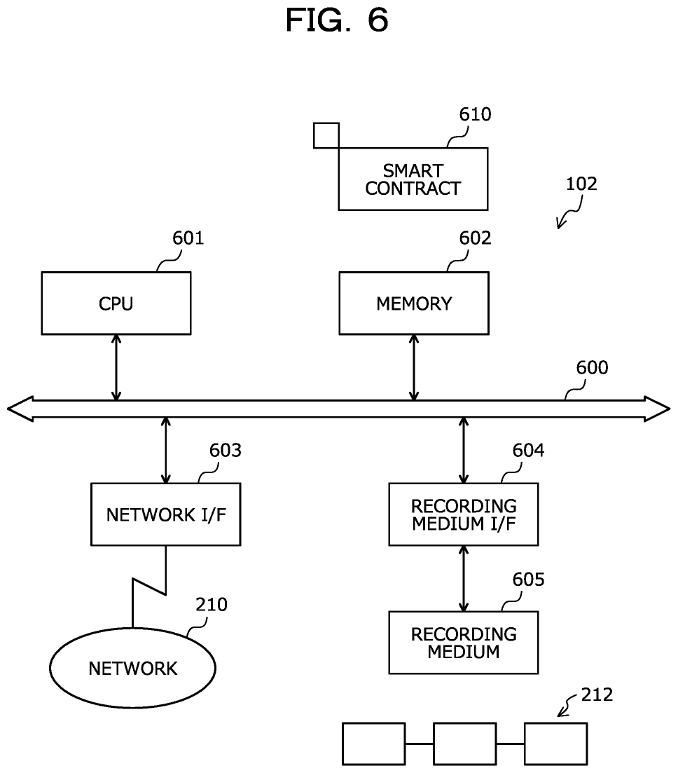

Next, an exemplary hardware configuration of the second node 102 will be described with reference to FIG. 6.

FIG. 6 is a block diagram illustrating an exemplary hardware configuration of the second node 102. In FIG. 6, the second node 102 includes a CPU 601, a memory 602, a network I/F 603, a recording medium I/F 604, and a recording medium 605. Furthermore, the individual components are coupled to each other by a bus 600.

Here, the CPU 601 takes overall control of the second node 102. The memory 602 includes, for example, a ROM, a RAM, a flash ROM, and the like. Specifically, the flash ROM or the ROM stores various programs, and the RAM is used as a work area for the CPU 601, for example. The programs stored in the memory 602 are loaded into the CPU 601 to cause the CPU 601 to execute coded processing.

Specifically, the memory 602 stores a smart contract 610. The smart contract 610 manages the second BC 212 that records enabled transaction information. The smart contract 610 receives information indicating transaction information from the information processing device 100. The smart contract 610 generates a block including the received information indicating transaction information, and adds it to the second BC 212 managed by the its own node.

The network I/F 603 is coupled to the network 210 through a communication line, and is coupled to another computer via the network 210. Then, the network I/F 603 takes control of an interface between the network 210 and the inside, and controls input/output of data to/from the another computer. The network I/F 603 is, for example, a modem, a LAN adapter, or the like.

The recording medium I/F 604 controls read/write of data from/to the recording medium 605 under the control of the CPU 601. The recording medium I/F 604 is, for example, a disk drive, an SSD, a USB port, or the like. The recording medium 605 is a nonvolatile memory that stores data written under the control of the recording medium I/F 604. The recording medium 605 stores, for example, the second BC 212. The recording medium 605 is, for example, a disk, a semiconductor memory, a USB memory, or the like. The recording medium 605 may be attachable to and detachable from the second node 102.

For example, the second node 102 may include, in addition to the components described above, a keyboard, a mouse, a display, a printer, a scanner, a microphone, a speaker, and the like. Furthermore, the second node 102 may include a plurality of the recording medium I/Fs 604 and the recording media 605. Furthermore, the second node 102 may not include the recording medium I/F 604 or the recording medium 605.

(Exemplary Functional Configuration of Control System 110)

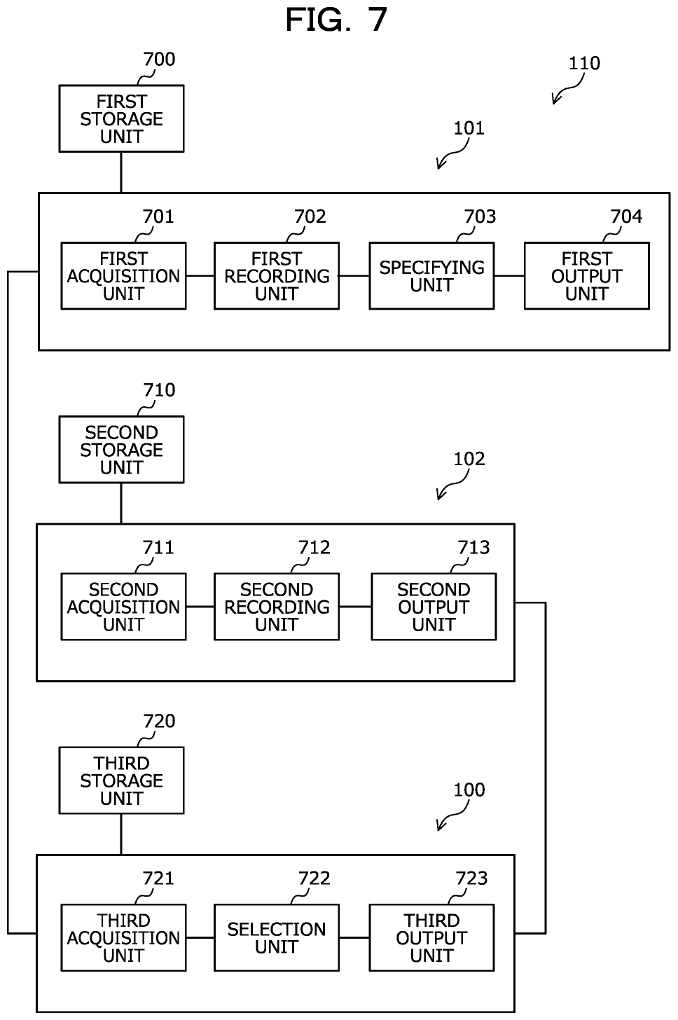

Next, an exemplary functional configuration of the control system 110 will be described with reference to FIG. 7.

FIG. 7 is a block diagram illustrating an exemplary functional configuration of the control system 110. In FIG. 7, the control system 110 includes a plurality of first nodes 101 that forms the first BC network 201, one or more second nodes 102 that form the second BC network 202, and the information processing device 100.

The first node 101 includes a first storage unit 700, a first acquisition unit 701, a first recording unit 702, a specifying unit 703, and a first output unit 704. The first storage unit 700 is implemented by, for example, a storage area such as the memory 402 or the recording medium 405 illustrated in FIG. 4. While a case where the first storage unit 700 is included in the first node 101 will be described below, it is not limited to this. For example, the first storage unit 700 may be included in a device different from the first node 101, and storage contents of the first storage unit 700 may be referred to by the first node 101.

The first acquisition unit 701 to the first output unit 704 function as an exemplary control unit. Specifically, the first acquisition unit 701 to the first output unit 704 implement functions thereof by causing the CPU 401 to execute a program stored in a storage area such as the memory 402 or the recording medium 405 illustrated in FIG. 4, or by the network I/F 403, for example. A processing result of each functional unit is stored in, for example, a storage area such as the memory 402 or the recording medium 405 illustrated in FIG. 4.

The first storage unit 700 stores various types of information to be referred to or updated in the processing of each functional unit. The first storage unit 700 stores the first BC 211 that records a scheduled time point at which transaction information is enabled. The transaction information is, for example, information indicating contents of a certain transaction. The transaction indicates, for example, a deposit, a remittance, or the like. To be enabled indicates, for example, transaction information is made active. To be enabled corresponds to, for example, the transaction indicated by the transaction information is executed.

The scheduled time point is expressed in a time format, for example. The scheduled time point is expressed by a time point of addition at which a predetermined block is added to the first BC 211, for example. The predetermined block is, for example, an N-th block from the top of the first BC 211. The time point of addition is represented by a block number N, for example.

The first BC 211 is formed by, for example, linking blocks that record a scheduled time point at which transaction information is enabled. Specifically, the first BC 211 is formed by linking blocks that record information indicating transaction information and a scheduled time point at which the transaction information is enabled in association with each other. For example, the blocks further record information indicating transaction information for which the scheduled time point has elapsed. The predetermined condition is, for example, a predetermined number of nodes. The predetermined condition may be variable for each piece of transaction information. The predetermined condition may include that a participation time of the node in the BC network is long. The predetermined condition may include that the node is highly reliable.

Furthermore, the first storage unit 700 stores a smart contract that records a scheduled time point of transaction information in the first BC 211. Furthermore, the first storage unit 700 stores a smart contract that specifies transaction information for which a scheduled time point has elapsed.

The first acquisition unit 701 obtains various types of information to be used for the processing of each functional unit. The first acquisition unit 701 stores the obtained various types of information in the first storage unit 700, or outputs them to each functional unit. Furthermore, the first acquisition unit 701 may output the various types of information stored in the first storage unit 700 to each functional unit. The first acquisition unit 701 obtains the various types of information based on an operation input made by a user, for example. The first acquisition unit 701 may receive the various types of information from a device different from the first node 101, for example.

The first acquisition unit 701 accepts a recording request for recording a scheduled time point at which any transaction information is enabled. The recording request includes, for example, information indicating any transaction information to be enabled and a scheduled time point at which the transaction information is enabled. The first acquisition unit 701 accepts the recording request by, for example, receiving the recording request from the client device 203.

The first acquisition unit 701 obtains a cancellation request for canceling a scheduled time point at which any transaction information is enabled. The cancellation request includes, for example, information indicating any transaction information for canceling the scheduled time point. The first acquisition unit 701 accepts the cancellation request by, for example, receiving the cancellation request from the client device 203.

The first acquisition unit 701 may accept a start trigger for starting processing of any functional unit. The start trigger is, for example, a predetermined operation input made by the user. The start trigger may be, for example, reception of predetermined information from another computer. The start trigger may be, for example, output of predetermined information from any functional unit.

The first acquisition unit 701 accepts, for example, reception of the recording request or the cancellation request as a start trigger for starting processing of the first recording unit 702. The first acquisition unit 701 accepts, for example, update of the first BC 211 by the first recording unit 702 as a start trigger for starting processing of the specifying unit 703. The first acquisition unit 701 accepts, for example, generation of a predetermined signal that is periodically generated as a start trigger for starting the processing of the specifying unit 703.

The first recording unit 702 manages the first BC 211. For example, the first recording unit 702 records a scheduled time point at which any transaction information is enabled in the first BC 211 when the recording request is accepted. Specifically, the first recording unit 702 generates a block including correspondence information in which information indicating any transaction information to be enabled is associated with the scheduled time point at which the transaction information is enabled, and adds it to the first BC 211. The generation may be carried out by a computer other than the first node 101 by requesting the computer to carry out the generation. As a result, the first recording unit 702 is enabled to appropriately update the first BC 211, and to manage the first BC 211.

For example, the first recording unit 702 records cancellation information indicating cancellation of a scheduled time point at which any transaction information is enabled in the first BC 211 when the cancellation request is accepted. Specifically, the first recording unit 702 generates a block including the cancellation information indicating cancellation of a scheduled time point at which any transaction information is enabled, and adds it to the first BC 211. As a result, the first recording unit 702 is enabled to cancel a scheduled time point at which transaction information is enabled without deleting the scheduled time point itself at which the transaction information is enabled from the first BC 211, which may improve convenience.

For example, the first recording unit 702 records a scheduled time point at which dummy transaction information is enabled in the first BC 211 when no recording request is accepted in a certain period. Specifically, the first recording unit 702 generates a block including the scheduled time point at which the dummy transaction information is enabled, and adds it to the first BC 211. As a result, the first recording unit 702 is enabled to generate a start trigger for starting the processing of the specifying unit 703 without accepting the recording request.

The specifying unit 703 specifies transaction information for which a scheduled time point has elapsed based on the recorded contents of the first BC 211. The processing of the specifying unit 703 is implemented by, for example, using a smart contract. For example, each time a certain number of new blocks are added to the first BC 211, the specifying unit 703 specifies the transaction information for which the scheduled time point has elapsed based on the recorded contents of the first BC 211. The certain number is, for example, a number of 1, or 2 or more. As a result, when the certain number is 1, the specifying unit 703 is enabled to suppress a delay from a certain scheduled time point until the scheduled time point is determined to be elapsed. When the certain number is 2 or more, the specifying unit 703 is enabled to reduce a processing amount.

For example, the specifying unit 703 specifies, based on the recorded contents of the first BC 211, transaction information for which a scheduled time point has elapsed other than any transaction information for which the scheduled time point has been canceled. Specifically, each time a certain number of new blocks are added to the first BC 211, the specifying unit 703 specifies, based on the recorded contents of the first BC 211, transaction information for which a scheduled time point has elapsed other than any transaction information for which the scheduled time point has been canceled. As a result, the specifying unit 703 is enabled to appropriately specify transaction information for which a scheduled time point has elapsed while excluding any transaction information for which the scheduled time point has been canceled.

The specifying unit 703 records a result of the specification in the first BC 211. For example, the specifying unit 703 records information indicating the transaction information specified by the specifying unit 703 in the first BC 211. As a result, the specifying unit 703 is enabled to allow the information processing device 100 to refer to the information indicating the transaction information specified by the first node 101 satisfying the predetermined condition.

The first output unit 704 outputs a processing result of at least any one of the functional units. An output format is, for example, display on a display, a print output to a printer, transmission to an external device by the network I/F 403, or storage in a storage area such as the memory 402, or the recording medium 405. As a result, the first output unit 704 may allow the user to be notified of the processing result of at least any one of the functional units, and may improve convenience of the first node 101.

The first output unit 704 outputs, for example, the recorded contents of the first BC 211. Specifically, the first output unit 704 transmits the recorded contents of the first BC 211 to the information processing device 100. As a result, the first output unit 704 may allow the information processing device 100 to grasp the recorded contents of the first BC 211.

The second node 102 includes a second storage unit 710, a second acquisition unit 711, a second recording unit 712, and a second output unit 713. The second storage unit 710 is implemented by, for example, a storage area such as the memory 602 or the recording medium 605 illustrated in FIG. 6. While a case where the second storage unit 710 is included in the second node 102 will be described below, it is not limited to this. For example, the second storage unit 710 may be included in a device different from the second node 102, and storage contents of the second storage unit 710 may be referred to by the second node 102.

The second acquisition unit 711 to the second output unit 713 function as an exemplary control unit. Specifically, the second acquisition unit 711 to the second output unit 713 implement functions thereof by causing the CPU 601 to execute a program stored in a storage area such as the memory 602 or the recording medium 605 illustrated in FIG. 6, or by the network I/F 603, for example. A processing result of each functional unit is stored in, for example, a storage area such as the memory 602 or the recording medium 605 illustrated in FIG. 6.

The second storage unit 710 stores various types of information to be referred to or updated in the processing of each functional unit. The second storage unit 710 stores the second BC 212 that records enabled transaction information. The second BC 212 is formed by, for example, linking blocks that record enabled transaction information. Furthermore, the second storage unit 710 stores a smart contract that records enabled transaction information in the second BC 212.

The second acquisition unit 711 obtains various types of information to be used for the processing of each functional unit. The second acquisition unit 711 stores the obtained various types of information in the second storage unit 710, or outputs them to each functional unit. Furthermore, the second acquisition unit 711 may output the various types of information stored in the second storage unit 710 to each functional unit. The second acquisition unit 711 obtains the various types of information based on an operation input made by the user, for example. The second acquisition unit 711 may receive the various types of information from a device different from the second node 102, for example. For example, the second acquisition unit 711 receives enabled transaction information from the information processing device 100. For example, the second acquisition unit 711 may receive information indicating the enabled transaction information from the information processing device 100.

The second acquisition unit 711 may accept a start trigger for starting processing of any functional unit. The start trigger is, for example, a predetermined operation input made by the user. The start trigger may be, for example, reception of predetermined information from another computer. The start trigger may be, for example, output of predetermined information from any functional unit. The second acquisition unit 711 accepts, for example, reception of the enabled transaction information as a start trigger for starting processing of the second recording unit 712. The second acquisition unit 711 accepts, for example, reception of information indicating the enabled transaction information as a start trigger for starting the processing of the second recording unit 712.

The second recording unit 712 manages the second BC 212 that records enabled transaction information. For example, the second recording unit 712 generates a block including the received transaction information, and adds it to the second BC 212. For example, the second recording unit 712 generates a block including information indicating the received transaction information, and adds it to the second BC 212. For example, the second recording unit 712 obtains the transaction information based on the information indicating the received transaction information, generates a block including the obtained transaction information, and adds it to the second BC 212. As a result, the second recording unit 712 is enabled to appropriately update the second BC 212.

The second output unit 713 outputs a processing result of at least any one of the functional units. An output format is, for example, display on a display, a print output to a printer, transmission to an external device by the network I/F 603, or storage in a storage area such as the memory 602, the recording medium 605, or the like. As a result, the second output unit 713 may allow the user to be notified of the processing result of at least any one of the functional units, and may improve convenience of the second node 102. The second output unit 713 outputs, for example, the recorded contents of the second BC 212.

The information processing device 100 includes a third storage unit 720, a third acquisition unit 721, a selection unit 722, and a third output unit 723. The third storage unit 720 is implemented by, for example, a storage area such as the memory 602 or the recording medium 605 illustrated in FIG. 6. While a case where the third storage unit 720 is included in the information processing device 100 will be described below, it is not limited to this. For example, the third storage unit 720 may be included in a device different from the information processing device 100, and storage contents of the third storage unit 720 may be referred to by the information processing device 100.

The third acquisition unit 721 to the third output unit 723 function as an exemplary control unit. Specifically, the third acquisition unit 721 to the third output unit 723 implement functions thereof by causing the CPU 601 to execute a program stored in a storage area such as the memory 602 or the recording medium 605 illustrated in FIG. 6, or by the network I/F 603, for example. A processing result of each functional unit is stored in, for example, a storage area such as the memory 602 or the recording medium 605 illustrated in FIG. 6.

The third storage unit 720 stores various types of information to be referred to or updated in the processing of each functional unit. The third storage unit 720 stores the recorded contents of the first BC 211. The third storage unit 720 stores, for example, recorded contents of the first BC 211 in which information indicating transaction information specified by the first node 101 is recorded.

The third acquisition unit 721 obtains various types of information to be used for the processing of each functional unit. The third acquisition unit 721 stores the obtained various types of information in the third storage unit 720, or outputs them to each functional unit. Furthermore, the third acquisition unit 721 may output the various types of information stored in the third storage unit 720 to each functional unit. The third acquisition unit 721 obtains the various types of information based on an operation input made by the user, for example. The third acquisition unit 721 may receive various types of information from a device different from the information processing device 100, for example.

The third acquisition unit 721 obtains, for example, the recorded contents of the first BC 211. Specifically, the third acquisition unit 721 receives the recorded contents of the first BC 211 from each of the first nodes 101. The third acquisition unit 721 may accept a start trigger for starting processing of any functional unit. The start trigger is, for example, a predetermined operation input made by the user. The start trigger may be, for example, reception of predetermined information from another computer. The start trigger may be, for example, output of predetermined information from any functional unit. The third acquisition unit 721 accepts, for example, acquisition of the recorded contents of the first BC 211 as a start trigger for starting processing of the selection unit 722.

The selection unit 722 carries out consensus building based on the recorded contents of the first BC 211, and selects the transaction information specified by the first node 101 that satisfies a predetermined condition among the plurality of first nodes 101. For example, the selection unit 722 carries out the consensus building based on the recorded contents of the first BC 211, and selects the transaction information specified by equal to or more than a predetermined number of the first nodes 101 in common among the plurality of first nodes 101. As a result, the selection unit 722 is enabled to select transaction information for which a scheduled time point has elapsed in a decentralized manner, which may improve security.

Furthermore, specifically, the selection unit 722 may select the transaction information specified by the first node 101 having a predetermined attribute among the plurality of first nodes 101 based on the recorded contents of the first BC 211. Furthermore, specifically, the selection unit 722 may further determine whether or not the transaction information specified by the first node 101 that satisfies a predetermined condition among the plurality of first nodes 101 satisfies an execution condition based on the recorded contents of the first BC 211. Then, the selection unit 722 may select the transaction information that satisfies the execution condition.

The third output unit 723 outputs a processing result of at least any one of the functional units. An output format is, for example, display on a display, a print output to a printer, transmission to an external device by the network I/F 603, or storage in a storage area such as the memory 602, the recording medium 605, or the like. As a result, the third output unit 723 may allow the user to be notified of the processing result of at least any one of the functional units, and may improve convenience of the information processing device 100. The third output unit 723 transmits information indicating the transaction information selected by the selection unit 722 to each of the second nodes 102. As a result, the third output unit 723 is enabled to update the second BC 212.

(Exemplary Operation of Control System 110)

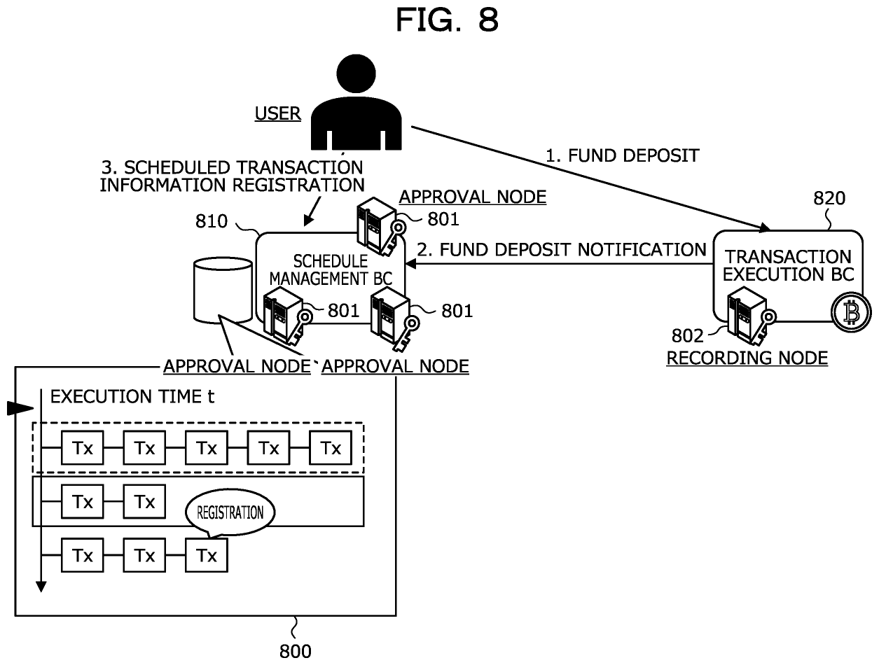

Next, exemplary operation of the control system 110 will be described with reference to FIGS. 8 to 11.

FIGS. 8 to 11 are explanatory diagrams illustrating exemplary operation of the control system 110. In FIG. 8, (8-1) the client device 203 transmits, to a transaction execution BC network, escrow transaction information related to an escrow transaction for depositing funds based on an operation input made by the user. The client device 203 transmits, for example, the escrow transaction information related to the escrow transaction for depositing funds to each of recording nodes 802 forming the transaction execution BC network. Each of the recording nodes 802 generates a block including the received escrow transaction information at predetermined timing, and adds it to a transaction execution BC 820.

(8-2) Any of the recording nodes 802 transmits the escrow transaction information recorded in the block added to the transaction execution BC 820 to a schedule management BC network. Any of the recording nodes 802 transmits the escrow transaction information recorded in the block added to the transaction execution BC 820 to, for example, each of approval nodes 801 forming the schedule management BC network. For example, any of the recording nodes 802 may transmit the escrow transaction information to any of the approval nodes 801 forming the schedule management BC network, thereby causing the escrow transaction information to be distributed from the approval node 801 to another approval node 801.

(8-3) The client device 203 transmits, to the schedule management BC network, a registration request of scheduled time at which scheduled transaction information indicating contents of the scheduled transaction to be executed with reference to the contents of the escrow transaction is enabled based on the operation input made by the user. The registration request includes, for example, the scheduled transaction information and the scheduled time at which the scheduled transaction information is enabled. The registration request may further include, for example, identification information for identifying the escrow transaction information. Specifically, the registration request includes the scheduled transaction management information 500.

For example, the client device 203 transmits the registration request to each of the approval nodes 801 forming the schedule management BC network. For example, the client device 203 may transmit the registration request to any of the approval nodes 801 forming the schedule management BC network, thereby causing the registration request to be distributed from the approval node 801 to another approval node 801.

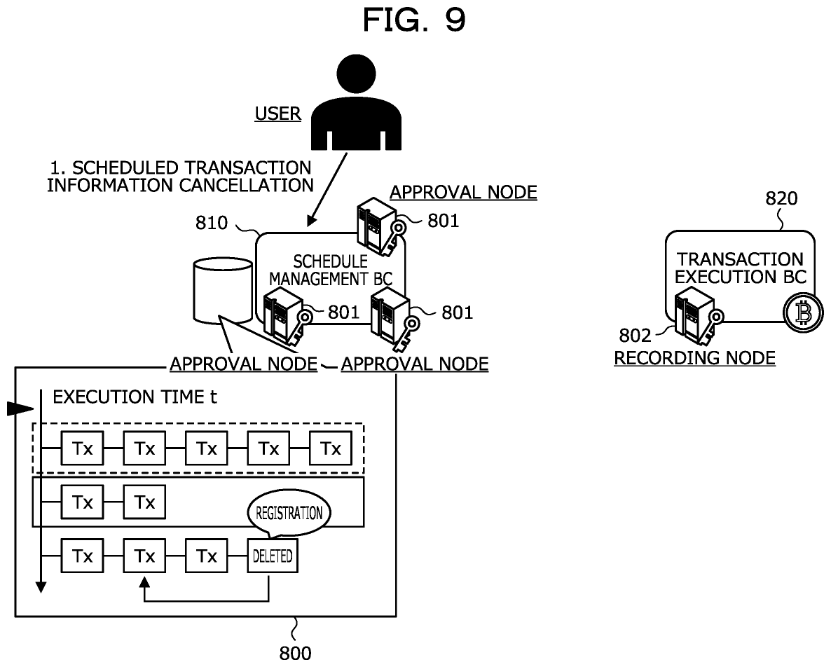

Each of the approval nodes 801 generates a block including the scheduled transaction information corresponding to the received registration request and the scheduled time at which the scheduled transaction information is enabled at predetermined timing, and records it in a schedule management BC 810. For example, each of the approval nodes 801 generates a block including the scheduled transaction management information 500 corresponding to the received registration request at predetermined timing, and records it in the schedule management BC 810. As a result, each of the approval nodes 801 is enabled to store a plan 800 for enabling the scheduled transaction information of each of them as a local database. Next, description proceeds to FIG. 9.

In FIG. 9, (9-1) the client device 203 transmits, to the schedule management BC network, a cancellation request for canceling scheduled time at which scheduled transaction information is enabled based on an operation input made by the user. The cancellation request includes, for example, identification information for identifying the scheduled transaction information for which the scheduled time is to be canceled.

For example, the client device 203 transmits the cancellation request to each of the approval nodes 801 forming the schedule management BC network. For example, the client device 203 may transmit the cancellation request to any of the approval nodes 801 forming the schedule management BC network, thereby causing the cancellation request to be distributed from the approval node 801 to another approval node 801.

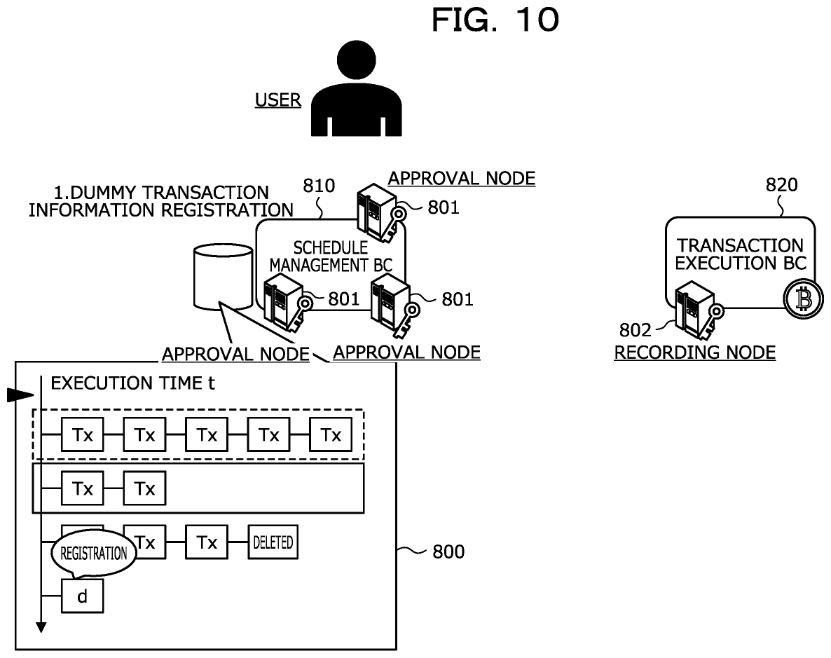

Each of the approval nodes 801 generates, at predetermined timing, a block including the identification information for identifying the scheduled transaction information for which the scheduled time is to be canceled corresponding to the received cancellation request, and records it in the schedule management BC 810. As a result, each of the approval nodes 801 is enabled to cancel the scheduled time point at which the scheduled transaction information is enabled without deleting the scheduled time itself from the schedule management BC 810, which may improve convenience. Next, description proceeds to FIG. 10.

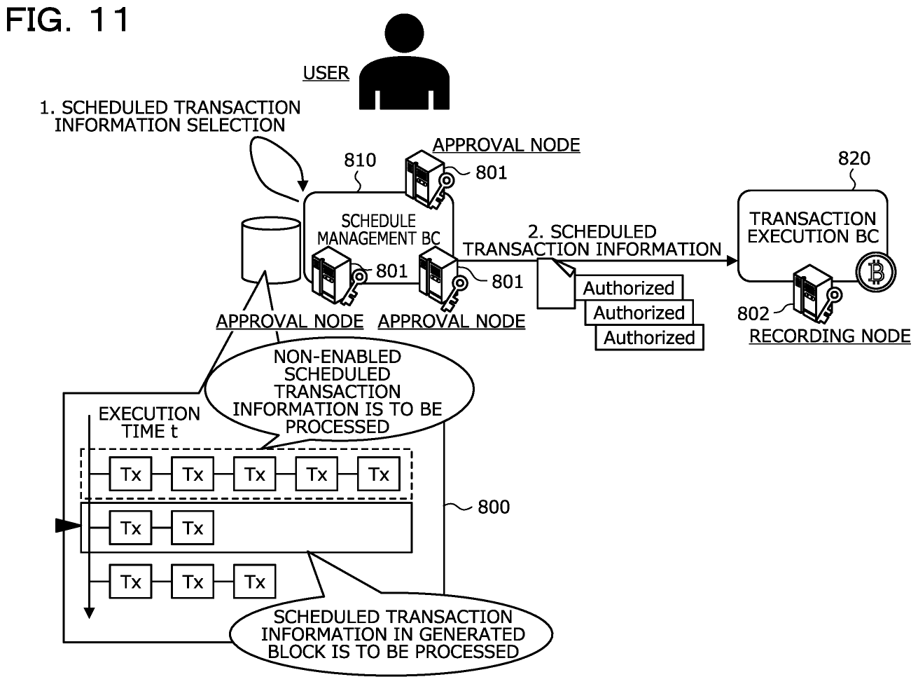

In FIG. 10, (10-1) when the registration request has not been received for a certain period of time, each of the approval nodes 801 generates a block including dummy transaction information, and records it in the schedule management BC 810. As a result, each of the approval nodes 801 is enabled to generate a trigger for determining whether or not scheduled transaction information for which scheduled time has elapsed exists, and to specify the scheduled transaction information for which the scheduled time has elapsed at appropriate timing. Next, description proceeds to FIG. 11.

In FIG. 11, (11-1) each of the approval nodes 801 refers to the recorded contents of the schedule management BC 810 each time a block is generated a certain number of times to specify scheduled transaction information for which scheduled time has elapsed. The certain number of times is, for example, once. Each of the approval nodes 801 generates approval information indicating approval for enabling the specified scheduled transaction information as the scheduled time for enabling the specified scheduled transaction information has elapsed, and records it in the schedule management BC 810.

The approval information includes, for example, a signature indicating approval for enabling the scheduled transaction information. The approval corresponds to an approval for executing the scheduled transaction associated with the scheduled transaction information. The approval information includes, for example, the specified scheduled transaction information and a signature indicating approval for enabling the scheduled transaction information.

Each of the approval nodes 801 determines, for example, whether or not each scheduled time at which scheduled transaction information is enabled, which is recorded in the generated block, has elapsed. Furthermore, each of the approval nodes 801 determines, for example, whether or not each scheduled time at which scheduled transaction information that has not been enabled is enabled, which is recorded in another block before the generated block, has elapsed. For example, each of the approval nodes 801 specifies the scheduled transaction information for which the scheduled time has elapsed based on a result of the determination. For example, each of the approval nodes 801 generates approval information based on a result of the specification, and records it in the schedule management BC 810.

(11-2) The information processing device 100 receives the schedule management BC 810 from each of the approval nodes 801. The information processing device 100 carries out consensus building based on the approval information recorded in the received schedule management BC 810, and selects the scheduled transaction information approved to be enabled by equal to or more than a certain number of the approval nodes 801.

The selected scheduled transaction information is transmitted to the recording node 802, which achieves the scheduled transaction for transmitting, to a set destination, funds of a predetermined remittance amount deposited by the escrow transaction specified by the escrow transaction ref included in the scheduled transaction information. Furthermore, in a case where the scheduled time for enabling is canceled and no scheduled transaction information is selected, the scheduled transaction for transmitting the funds of the predetermined remittance amount deposited by the escrow transaction to the set destination is not executed. At this time, the deposit by the escrow transaction may also be canceled.

The information processing device 100 transmits the selected scheduled transaction information to the transaction execution BC network. For example, the information processing device 100 transmits the selected scheduled transaction information to each of the recording nodes 802 forming the transaction execution BC network. Each of the recording nodes 802 generates a block including the received scheduled transaction information at predetermined timing, and adds it to a transaction execution BC 820. As a result, the control system 110 is enabled to schedule the operation of enabling the scheduled transaction information.

### Specific Example of Operation of Control System 110

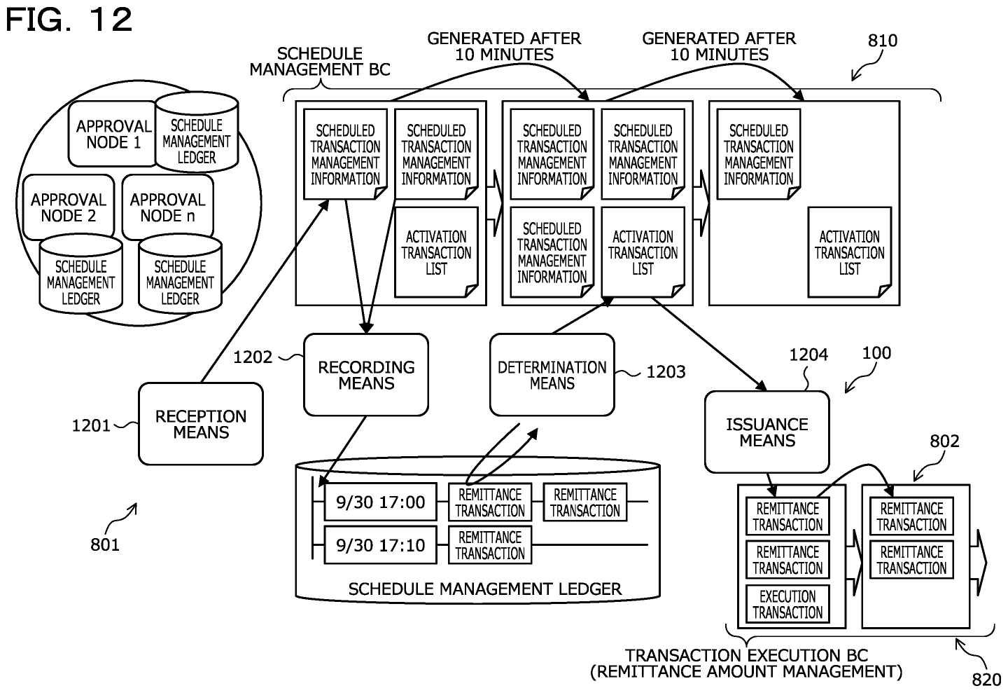

Next, specific examples of operation of the control system 110 will be described with reference to FIGS. 12 to 15.

FIGS. 12 to 15 are explanatory diagrams illustrating specific examples of the operation of the control system 110. In FIG. 12, the approval node 801 includes a reception means 1201, a recording means 1202, and a determination means 1203. The information processing device 100 includes an issuance means 1204.

The approval node 801 stores the schedule management BC 810. Furthermore, the approval node 801 stores a schedule management ledger that manages scheduled time at which scheduled transaction information is enabled based on the schedule management BC 810. For example, the schedule management ledger is stored as a local database. For example, the schedule management ledger indicates, for each scheduled time, the scheduled transaction information to be enabled at the scheduled time in association with each other. The schedule management ledger may indicate enabled scheduled transaction information in a manner of being identifiable.

The approval node 801 generates a block to be added to the schedule management BC 810 every 10 minutes. The reception means 1201 accepts a registration request including scheduled time at which scheduled transaction information is enabled. The registration request includes the scheduled transaction management information 500.

Each time a block is generated, the reception means 1201 includes, in the block to be added to the schedule management BC 810, the scheduled transaction management information 500 included in each registration request accepted during the immediately preceding 10 minutes. Each time a block is generated, the determination means 1203 specifies scheduled transaction information for which scheduled time has elapsed based on the schedule management ledger.

The determination means 1203 generates approval information including a signature indicating approval for enabling the specified scheduled transaction information, and generates an activation transaction list including the specified scheduled transaction information and the generated approval information in association with each other. The determination means 1203 includes the generated activation transaction list in a block to be added to the schedule management BC 810. The approval node 801 adds the generated block to the schedule management BC 810.

The recording means 1202 updates the schedule management ledger based on the recorded contents of the schedule management BC 810 each time a block is generated. The recording means 1202 specifies scheduled transaction information that has not been enabled yet based on the scheduled transaction management information 500 recorded in the block added to the schedule management BC 810. The recording means 1202 registers, in the schedule management ledger, the specified scheduled transaction information that has not been enabled yet and the scheduled time at which the scheduled transaction information is enabled in association with each other.

The approval node 801 transmits the activation transaction list recorded in the block added to the schedule management BC 810 to the information processing device 100. The issuance means 1204 receives the activation transaction list recorded in the block added to the schedule management BC 810. The issuance means 1204 carries out consensus building based on the received activation transaction list, and selects scheduled transaction information for which scheduled time has elapsed specified by equal to or more than a predetermined number of the approval nodes 801 in common.

The issuance means 1204 transmits the selected scheduled transaction information to each of the recording nodes 802 forming the transaction execution BC network. The issuance means 1204 may further determine, for example, whether or not a schedule execution condition corresponding to the selected scheduled transaction information is satisfied. Then, in a case where the schedule execution condition is satisfied, for example, the issuance means 1204 transmits the selected scheduled transaction information to each of the recording nodes 802 forming the transaction execution BC network.

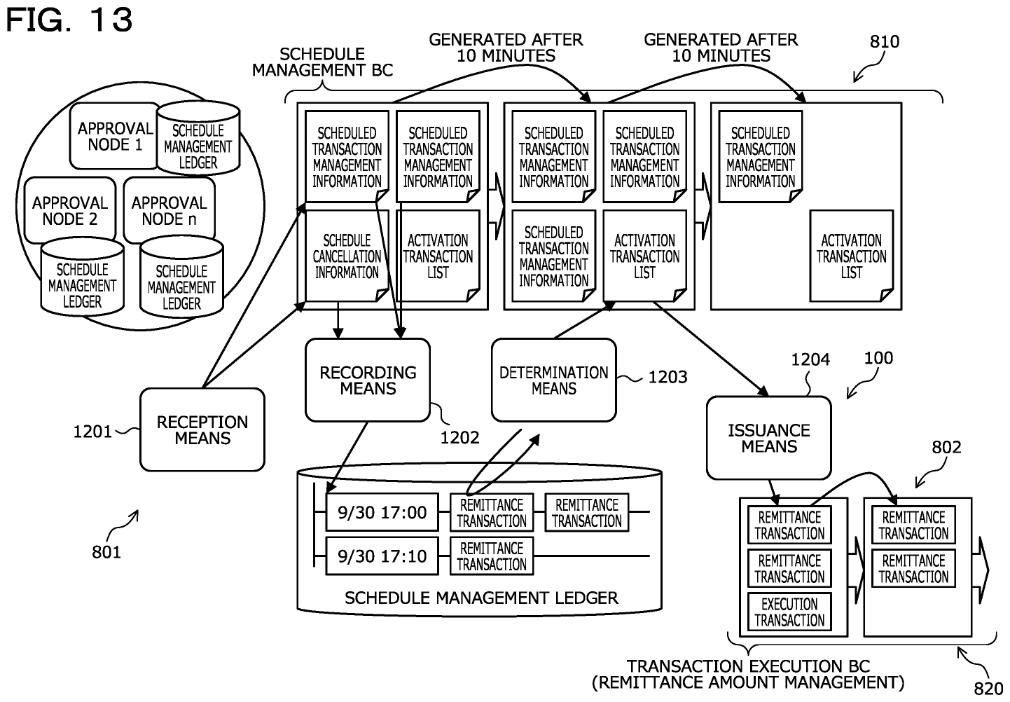

Each of the recording nodes 802 records the received scheduled transaction information in the transaction execution BC 820. As a result, the control system 110 is enabled to schedule the operation of recording the scheduled transaction information in the transaction execution BC 820, which may improve convenience. Next, description proceeds to FIG. 13.

In FIG. 13, the reception means 1201 accepts a cancellation request for canceling scheduled time at which scheduled transaction information is enabled. The cancellation request includes schedule cancellation information indicating scheduled transaction information to be canceled in a manner of being identifiable. Each time a block is generated, the reception means 1201 includes, in a block to be added to the schedule management BC 810, the schedule cancellation information included in each cancellation request accepted during the immediately preceding 10 minutes.

The recording means 1202 updates the schedule management ledger based on the recorded contents of the schedule management BC 810 each time a block is generated. The recording means 1202 obtains the scheduled transaction management information 500 recorded in the block added to the schedule management BC 810. The recording means 1202 registers, in the schedule management ledger, scheduled transaction information that has not been enabled yet and scheduled time at which the scheduled transaction information is enabled in association with each other based on the obtained scheduled transaction management information 500.

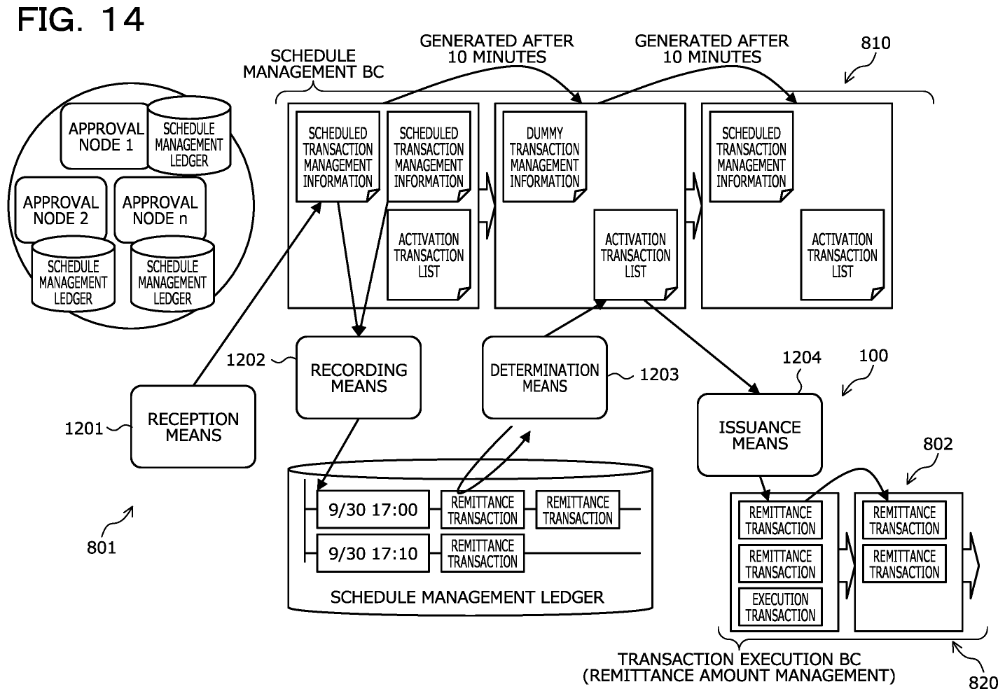

Furthermore, the recording means 1202 obtains the schedule cancellation information recorded in the block added to the schedule management BC 810. The recording means 1202 cancels the scheduled time registered in the schedule management ledger based on the schedule cancellation information. As a result, the control system 110 is enabled to cancel the scheduled time afterward, which may improve convenience. Next, description proceeds to FIG. 14.

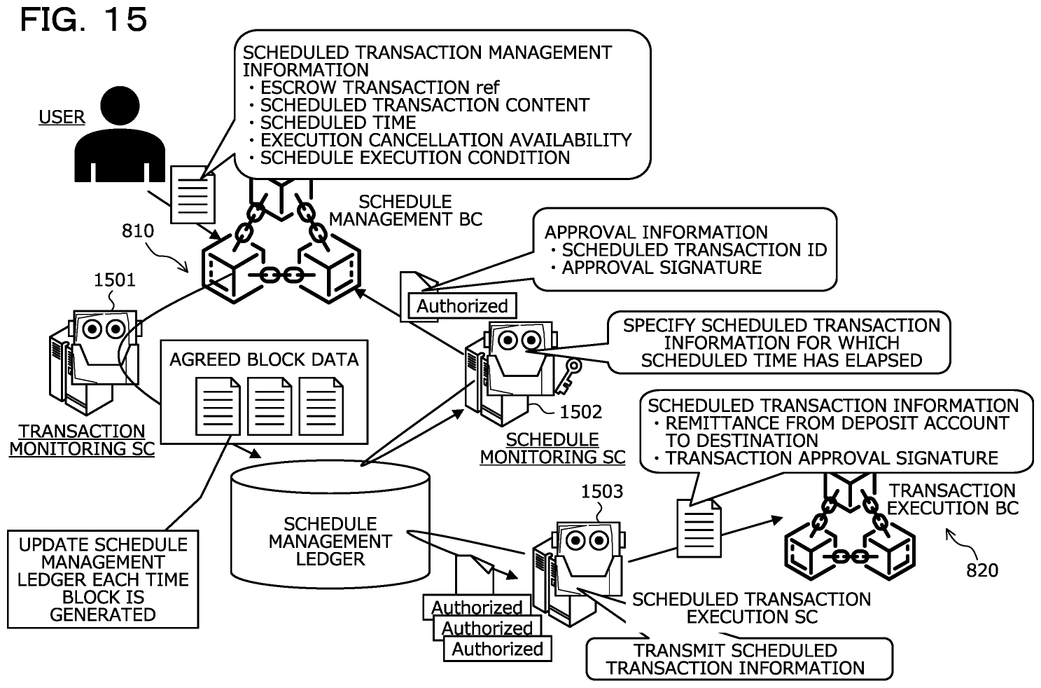

In FIG. 14, when a block is generated, the reception means 1201 includes dummy transaction management information in the block to be added to the schedule management BC 810 if a registration request has not been accepted during the immediately preceding 10 minutes. As a result, the control system 110 is enabled to execute the processing of the recording means 1202 and the determination means 1203 without accepting the registration request. Next, description proceeds to FIG. 15 to describe an application example of the control system 110.

In FIG. 15, the client device 203 transmits the scheduled transaction management information 500 to each of the approval nodes 801 forming the schedule management BC network. The approval node 801 adds a block including the scheduled transaction management information 500 to the schedule management BC 810 using a transaction monitoring SC 1501. The approval node 801 uses the transaction monitoring SC 1501 to update the schedule management ledger based on the block added to the schedule management BC 810.

The approval node 801 uses a schedule monitoring SC 1502 to specify scheduled transaction information for which scheduled time has elapsed based on the schedule management ledger. The approval node 801 generates, using the schedule monitoring SC 1502, approval information in which scheduled transaction ID for identifying the scheduled transaction information for which the scheduled time has elapsed is associated with a signature indicating approval for enabling the scheduled transaction information. The approval node 801 records the generated approval information in the schedule management BC 810 using the schedule monitoring SC 1502.

The information processing device 100 obtains the recorded contents of the schedule management BC 810 using a scheduled transaction execution SC 1503. The information processing device 100 selects, using the scheduled transaction execution SC 1503, scheduled transaction information for which scheduled time has elapsed determined to be appropriate by consensus building. For example, the information processing device 100 determines, using the scheduled transaction execution SC 1503, that scheduled transaction information for which scheduled time has elapsed approved to be enabled by equal to or more than a certain number of the approval nodes 801 is appropriate based on the consensus building.

The information processing device 100 transmits the selected scheduled transaction information to each of the recording nodes 802 forming the transaction execution BC network using the scheduled transaction execution SC 1503. The scheduled transaction information includes, for example, contents of the scheduled transaction for remitting money from a deposit account to a destination and a signature for transaction approval. As a result, the control system 110 is enabled to schedule the operation of recording the scheduled transaction information in the transaction execution BC 820.

(Overall Processing Procedure)

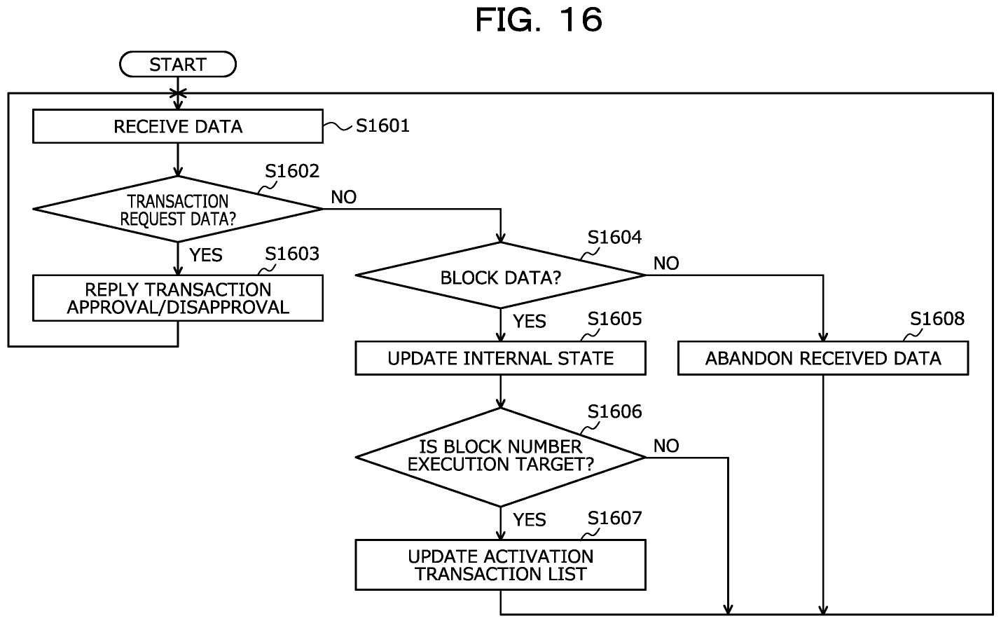

Next, an exemplary overall processing procedure to be executed by the approval node 801 will be described with reference to FIG. 16. The overall processing is achieved by, for example, the CPU 401, a storage area such as the memory 402 or the recording medium 405, and the network I/F 403 illustrated in FIG. 4.

FIG. 16 is a flowchart illustrating an example of the overall processing procedure. In FIG. 16, the approval node 801 receives data (step S1601). Next, the approval node 801 determines whether or not the received data is transaction request data for requesting recording of a scheduled time point at which scheduled transaction information is enabled (step S1602).

Here, if it is not the transaction request data (No in step S1602), the approval node 801 proceeds to processing of step S1604. On the other hand, if it is the transaction request data (Yes in step S1602), the approval node 801 proceeds to processing of step S1603.

In step S1603, the approval node 801 replies transaction approval/disapproval indicating whether or not to approve the scheduled transaction (step S1603). When the scheduled transaction is approved, the approval node 801 records the scheduled transaction information in the schedule management BC 810. Then, the approval node 801 returns to the processing of step S1601.

In step S1604, the approval node 801 determines whether or not the received data is block data (step S1604). Here, if it is not the block data (No in step S1604), the approval node 801 proceeds to processing of step S1608. On the other hand, if it is the block data (Yes in step S1604), the approval node 801 proceeds to processing of step S1605.

In step S1605, the approval node 801 updates an internal state based on the scheduled transaction information in the block data (step S1605). The internal state indicates a schedule management ledger. Next, the approval node 801 determines whether or not a block number is an execution target (step S1606). Here, if it is not the execution target (No in step S1606), the approval node 801 returns to the processing of step S1601. On the other hand, if it is the execution target (Yes in step S1606), the approval node 801 proceeds to processing of step S1607.

In step S1607, the approval node 801 updates the activation transaction list, and distributes it by P2P (step S1607). The approval node 801 causes the information processing device 100 to specify scheduled transaction information approved to be enabled by equal to or more than a predetermined number of the approval nodes 801 based on the distributed activation transaction list. Then, the approval node 801 returns to the processing of step S1601.

In step S1608, the approval node 801 abandons the received data (step S1608). Then, the approval node 801 returns to the processing of step S1601. As a result, the approval node 801 is enabled to schedule the operation of enabling the scheduled transaction information.

As described above, according to each of the first nodes 101, it becomes possible to manage the first BC that records a scheduled time point at which transaction information is enabled. According to each of the first nodes 101, it becomes possible to specify transaction information for which a scheduled time point has elapsed based on the recorded contents of the first BC managed by the node itself, and to record a result of the specification in the first BC managed by the node itself. According to the information processing device 100, it becomes possible to transmit transaction information specified by the first node 101 that satisfies a predetermined condition among the plurality of first nodes 101 to each of the second nodes 102 based on the recorded contents of the first BC. According to each of the second nodes 102, it becomes possible to manage the second BC that records enabled transaction information. According to each of the second nodes 102, it becomes possible to generate a block including the received transaction information to add it to the second BC managed by the node itself. As a result, the control system 110 is enabled to schedule an operation of recording transaction information in the second BC.

According to the information processing device 100, it becomes possible to transmit transaction information specified by equal to or more than a predetermined number of nodes of the plurality of first nodes 101 in common to each of the second nodes 102 based on the recorded contents of the first BC. As a result, the control system 110 is enabled to record the transaction information in the second BC when consensus building is carried out for the transaction information for which the scheduled time point has elapsed, which may improve security.

According to each of the first nodes 101, it becomes possible to accept a cancellation request for canceling a scheduled time point at which any transaction information is enabled. According to each of the first nodes 101, it becomes possible to generate, when the cancellation request is accepted, a block including cancellation information indicating cancellation of the scheduled time point at which any transaction information is enabled, and to added it to the first BC managed by the node itself. According to each of the first nodes 101, it becomes possible to specify transaction information for which a scheduled time point has elapsed other than any transaction information based on the recorded contents of the first BC managed by the node itself, and to record a result of the specification in the first BC managed by the node itself. As a result, the control system 110 is enabled to cancel a scheduled time point without deleting the scheduled time point itself from the first BC, which may improve convenience.

According to each of the first nodes 101, it becomes possible to generate, when a recording request for recording a scheduled time point at which any transaction information is enabled is accepted, a block including the scheduled time point at which any transaction information is enabled to add it to the first BC managed by the node itself. As a result, the control system 110 is enabled to update the first BC to the latest state.

According to each of the first nodes 101, it becomes possible to specify transaction information for which a scheduled time point has elapsed based on the recorded contents of the first BC managed by the node itself each time a certain number of new blocks are added to the first BC managed by the node itself. According to each of the first nodes 101, it becomes possible to record a result of the specification in the first BC managed by the node itself. As a result, the control system 110 is enabled to appropriately specify the transaction information for which the scheduled time point has elapsed at predetermined timing.

According to each of the first nodes 101, a number of 2 or more may be adopted as the certain number. As a result, the control system 110 is enabled to reduce a processing amount.

According to each of the first nodes 101, it becomes possible to generate a block including a scheduled time point at which dummy transaction information is enabled to add it to the first BC managed by the node itself when no recording request is accepted in a certain period. As a result, the control system 110 is enabled to update the first BC without accepting the recording request. Thus, the control system 110 is enabled to carry out consensus building for the transaction information for which the scheduled time point has elapsed.

According to each of the first nodes 101, it becomes possible to include a smart contract that specifies the transaction information specified by the first node 101 satisfying a predetermined condition. According to each of the first nodes 101, it becomes possible to specify, using the smart contract, transaction information for which a scheduled time point has elapsed based on the recorded contents of the first BC managed by the node itself. According to each of the first nodes 101, it becomes possible to record the transaction information in the first BC managed by the node itself when the transaction information is transaction information specified by the first node 101 satisfying the predetermined condition. As a result, the control system 110 is enabled to easily implement various types of processing using the smart contract.

According to each of the first nodes 101, it becomes possible to represent a scheduled time point with a time point of addition at which a predetermined block is added to the first BC. As a result, the control system 110 is enabled to represent the scheduled time point without using the time, which may improve convenience.

Note that the control method described in the present embodiment may be implemented by executing, in a computer such as a PC or a workstation, a program prepared in advance. The control program described in the present embodiment is executed by being recorded on a computer-readable recording medium and being read from the recording medium by the computer. The recording medium is a hard disk, a flexible disk, a compact disc (CD)-ROM, a magneto optical disc (MO), a digital versatile disc (DVD), or the like. Furthermore, the control program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control system comprising:
a plurality of nodes that forms a first blockchain network, each node of the plurality of nodes is configured to:
manage a first blockchain that records a scheduled time point at which transaction information is enabled,
specify the transaction information for which the scheduled time point has elapsed based on recorded contents of the first blockchain, and
record the specified transaction information in the first blockchain;
one or more nodes that form a second blockchain network;
an information processing device configured to
transmit the transaction information specified by a node of the plurality of nodes that satisfies a certain condition among the plurality of nodes to each node of the one or more nodes based on the recorded contents of the first blockchain,
wherein each node of the one or more nodes is configured to:
manage a second blockchain that records enabled transaction information,
generate a block that includes the transaction information transmitted by the information processing device, and
add the block to the second blockchain.

2. The control system according to claim 1, wherein
the certain condition includes a certain number of nodes, and
the information processing device is further configured to
transmit, to each node of the one or more nodes, the transaction information specified by equal to or more than the certain number of nodes among the plurality of nodes in common based on the recorded contents of the first blockchain.

3. The control system according to claim 1, wherein
each node of the plurality of nodes is further configured to:
when a cancellation request configured to cancel the scheduled time point at which one piece of the transaction information is enabled is accepted, generate a block that includes cancellation information that indicates cancellation of the scheduled time point at which the one piece of the transaction information is enabled,
add the block to the first blockchain, and
specify transaction information for which the scheduled time point has elapsed other than the one piece of the transaction information based on the recorded contents of the first blockchain and record the specified transaction information in the first blockchain.

4. The control system according to claim 1, wherein
each node of the plurality of nodes is further configured to:
when a recording request configured to record the scheduled time point at which one piece of the transaction information is enabled is accepted, generate a block that includes the scheduled time point at which the one piece of the transaction information is enabled, and
add the block to the first blockchain.

5. The control system according to claim 4, wherein
each node of the plurality of nodes is further configured to:
each time a certain number of new blocks are added to the first blockchain, specify the transaction information for which the scheduled time point has elapsed based on the recorded contents of the first blockchain, and
record the specified transaction information in the first blockchain.

6. The control system according to claim 5, wherein the certain number includes a number of 2 or more.

7. The control system according to claim 5, wherein
each node of the plurality of nodes is further configured to:
when the recording request is not accepted in a certain period, generate a block that includes the scheduled time point at which dummy transaction information is enabled, and
add the block to the first blockchain.

8. The control system according to claim 1, wherein
each node of the plurality of nodes is further configured to:
include a smart contract that specifies the transaction information specified by the node that satisfies the certain condition,
specify, using the smart contract, the transaction information for which the scheduled time point has elapsed based on the recorded contents of the first blockchain, and
when the transaction information is the transaction information specified by the node that satisfies the certain condition, record the transaction information in the first blockchain.

9. The control system according to claim 1, wherein the scheduled time point indicates a time point of addition at which a certain block is added to the first blockchain.

10. The control system according to claim 1, wherein
each node of the plurality of nodes adds the block to the second blockchain at a timing when the transaction information specified by the node of the plurality of nodes that satisfies the certain condition is transmitted.

11. A non-transitory computer-readable storage medium storing a control program that causes at least one computer to execute a process, the process comprising:
managing a first blockchain that records a scheduled time point at which transaction information is enabled; and
specifying the transaction information for which the scheduled time point has elapsed based on recorded contents of the first blockchain; and
recording the transaction information specified by a node that satisfies a certain condition among the plurality of nodes to each node of the one or more nodes based on the recorded contents of the first blockchain in the first blockchain, the transaction information being enable by the information processing device that transmits the transaction information to a node that manages a second blockchain that records enabled transaction information.

12. A control method for a computer to execute a process comprising:
managing a first blockchain that records a scheduled time point at which transaction information is enabled; and
specifying the transaction information for which the scheduled time point has elapsed based on recorded contents of the first blockchain; and
recording the transaction information specified by a node that satisfies a certain condition among the plurality of nodes to each node of the one or more nodes based on the recorded contents of the first blockchain in the first blockchain, the transaction information being enable by the information processing device that transmits the transaction information to a node that manages a second blockchain that records enabled transaction information.
